(19) United States
(12) Patent Application Publication
(10) Pub. No.: US 2008/0170488 A1
(43) Pub. Date: Jul. 17, 2008

(54) METHOD AND DEVICE FOR NON-DESTRUCTIVE READING FOR A FERROELECTRIC-MATERIAL STORAGE MEDIA

(75) Inventors: Maurizio Zuffada, Cornaredo (IT); Michele Fedeli, Pavia (IT); Guido Gabriele Albasini, Voghera (IT); Matteo Rossi, Pavia (IT)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMicroelectronics S.r.l., Agrate Brianza (IT)

(21) Appl. No.: 12/013,015

(22) Filed: Jan. 11, 2008

(30) Foreign Application Priority Data
Jan. 12, 2007 (IT) TO2007A 000017

(51) Int. Cl. G11B 9/00

(52) U.S. Cl. 369/126

(57) ABSTRACT

A method for non-destructive reading of a datum stored in a ferroelectric material in a stable state of polarization, the method including applying a read electrical quantity to the ferroelectric material having a value such as not to cause a variation in the stable state of polarization thereof, generating an output quantity indicative of a polarization charge variation occurring in the ferroelectric material during application of the read electrical quantity, and determining the value of the stored datum based on the output quantity. In particular, the polarization charge variation is given by a difference between a first value assumed by the polarization charge in the stable state of the ferroelectric material and a second value assumed by the polarization charge during application of the read electrical quantity.

### BACKGROUND

1. Technical Field

The present disclosure relates to a method and to a device for non-destructive reading for a ferroelectric-material storage media.

2. Description of the Related Art

As is known, in the field of storage systems, the need is felt to reach high storage capacities with high data-transfer rates (bit rates) while at the same time reducing the manufacturing costs and the area occupation. Currently, the most widely used storage systems, namely hard-disk drives (with miniaturized dimensions) and flash RAMs, have intrinsic technological limits as regards the increase in the data-storage capacity and the read/write speed, and the reduction in their dimensions. For example, in the case of hard disks, the “superparamagnetic limit” constitutes an obstacle to the reduction of the magnetic-storage domain size below a critical threshold, with the risk of loss of the stored information.

Amongst the innovative solutions proposed, storage systems using a storage media made of ferroelectric material offer considerable promise. In these storage systems reading/writing of individual bits is performed by interacting with the ferroelectric domains of the ferroelectric material.

As is known, ferroelectric material has a spontaneous polarization, which can be reversed by an applied electrical field. As illustrated in FIG. 1, this material has a hysteresis loop in the plot of the polarization charge Q (or, equivalently, of the polarization P) versus the applied voltage V, by exploiting which it is possible to store the information in the form of bits. In particular, in the absence of a biasing voltage applied to the media (V=0), there are two stable-state points of the plot (designated by “b” and “e”) having different, in particular equal and opposite, polarization. These points can remain in the stable state even for several years, thus maintaining the binary datum stored (for example, point “b”, with positive charge +Q_{H}, corresponds to a “0”, whilst point “e”, with negative charge −Q_{H}, corresponds to a “1”).

Writing operations envisage application to the ferroelectric media of a voltage, either positive or negative, higher than a coercive voltage V_{c}, which is characteristic of the ferroelectric material; a positive charge +Q_{H}, or a negative charge −Q_{H}, is thus stored in the material (this basically corresponding to a displacement along the plot from point “e” to point “b” passing through point “a”, or else from point “b” to point “e” passing through point “d”). A voltage with an absolute value smaller than the coercive voltage V_{c} does not cause a stable variation in the stored charge.

Commonly used data-reading techniques are based on a destructive operation, according to which the read data are cancelled. In brief, a voltage (either positive or negative) with amplitude greater than the coercive voltage V_{c} is applied to the ferroelectric material, performing in practice a writing operation, and the occurrence (or not) of a reversal of polarity of the ferroelectric material is detected. For this purpose, the presence (or not) of an appreciable current flowing in the ferroelectric material is detected. Clearly, the application of a positive (or negative) voltage causes reversal of the sole ferroelectric domains in which a negative charge −Q_{H} (or positive charge +Q_{H}) was previously stored.

The main problem of this reading technique is due to the fact that the reading operations are destructive, i.e., they imply removal of the information previously stored and hence the impossibility of performing successive readings of the same data, without previously performing a rewriting of the read data. In fact, reading of a portion of the memory corresponds to writing in this portion of memory a sequence of charges that are all positive (or all negative, if a negative reading voltage is used). Consequently, during reading, the flow of the read data must be stored in a memory buffer, and subsequently a writing operation is necessary for restoring the original information.

This reading technique involves a considerable waste of time and power, and basically constitutes a bottleneck for current ferroelectric storage systems, in particular as regards their bit rate.

To overcome this problem, non-destructive techniques for reading the stored data have been proposed.

For example in Cho et al., “Terabit inch⁻² ferroelectric data storage using scanning nonlinear dielectric microscopy nanodomain engineering system,” Nanotechnology No. 14, 2003, pp. 637-642, Institute of Physics Publishing, a sinusoidal signal is applied to a ring electrode, that induces an oscillation in a resonant circuit including the ferroelectric media in which the information bit is stored. A demodulator detects the harmonics of the induced oscillation, the phases of which are correlated to the stored information bit, on account of the different behavior of the higher order nonlinear dielectric constants of the ferroelectric material in the stable points of the polarization diagram.

In Kato et al., “0.18-μm nondestructive readout FeRAM using charge compensation technique,” IEEE Transactions on electron devices, Vol. 52, No. 12, December 2005, a read circuit is described that envisages connection in series of a ferroelectric capacitor (constituted by the storage media) to the gate terminal of a reading MOS transistor. By applying a reading pulse, the charge stored in the capacitor biases the gate terminal of the MOS transistor, in a different way according to the polarization state previously stored, thus varying the conductivity of the conduction channel. Next, the stored datum is read by detecting the current flowing between the current-conduction terminals of the MOS transistor, in a static condition, by means of a sense amplifier.

Although the above reading techniques have the advantage of not being destructive and hence of not requiring rewriting of the read data, they are not altogether satisfactory as regards the complexity of implementation and their operation.

### BRIEF SUMMARY

The present disclosure provides a non-destructive reading method for a ferroelectric storage media, which will enable the aforesaid problems and disadvantages to be overcome.

According to the present disclosure a method and a device for reading a ferroelectric storage media are consequently provided.

In accordance with one embodiment, a method for non-destructive reading of a datum stored in a ferroelectric material in a stable state of polarization is provided. The method includes applying a read electrical quantity to the ferroelectric material, having a value such as not to cause a variation of stable state of polarization of the ferroelectric material; generating an output quantity indicative of a polarization charge variation occurring in the ferroelectric material during application of the read electrical quantity; and determining the value of the stored datum based on the output quantity.

In accordance with another embodiment, a device for non-destructive reading of a datum stored in a ferroelectric material in a stable state of polarization is provided. The device includes an applying circuit configured to apply to the ferroelectric material a read electrical quantity having a value such as not to cause a variation of the stable state of polarization thereof; a generating circuit configured to generate an output quantity indicative of a polarization charge variation occurring in the ferroelectric material during application of the read electrical quantity, and a determining circuit configured to determine the value of the datum based on the output quantity.

In accordance with another embodiment, a method of reading a state of a ferroelectric storage device is provided. The method includes subjecting the ferroelectric storage device to a read electric voltage that does not change the state of the ferroelectric storage device, generating an output quantity responsive to the electric voltage and to the state of the ferroelectric storage device; and determining a value associated with a state of the ferroelectric storage device in response to the output quantity.

In accordance with another aspect of the foregoing embodiment, the read electric voltage has an amplitude smaller than a coercive voltage of the ferroelectric storage device. More particularly, the output quantity is indicative of a polarization charge variation in the ferroelectric storage device that is the difference between a first value of the polarization charge in a stable state of the ferroelectric storage device and a second value of the polarization charge when the ferroelectric storage device is subjected to the read electric voltage.

In accordance with another embodiment, a device for reading a state of a ferroelectric storage device is provided. The device includes a voltage generator configured to subject the ferroelectric storage device to a read electric voltage that does not change the state of the ferroelectric storage device; a processing stage adapted to generate an output quantity responsive to the electric voltage and to the state of the ferroelectric storage device; and an analysis stage adapted to determine a value associated with a state of the ferroelectric storage device in response to the output quantity.

### BRIEF DESCRIPTION OF THE SEVERAL VIEWS OF THE DRAWINGS

For a better understanding of the present disclosure, preferred embodiments thereof are now described, purely by way of non-limiting example and with reference to the attached drawings, wherein:

FIG. 1 shows a diagram of a hysteresis loop of a ferroelectric material of a storage media;

FIG. 2 shows a simplified circuit block diagram of a reading device according to an aspect of the present disclosure;

FIG. 3 shows a first circuit implementation of the reading device;

FIG. 4 shows the plot of some electrical quantities in the circuit of FIG. 3;

FIG. 5 shows a second circuit implementation of the reading device;

FIGS. 6 and 7 show the plots of some electrical quantities in the circuit of FIG. 5; and

FIG. 8 is a schematic representation of a ferroelectric storage system, including the reading device of FIG. 2.

### DETAILED DESCRIPTION

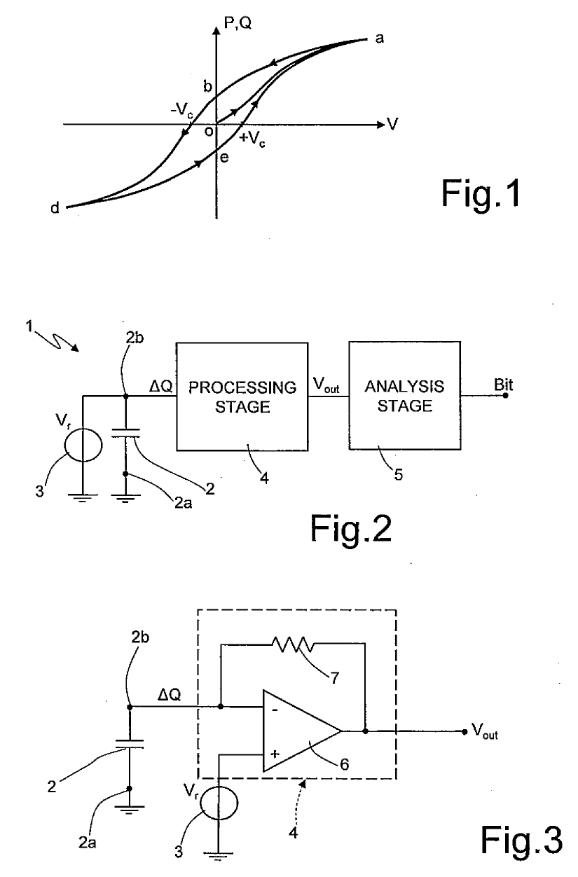

An aspect of the present disclosure envisages implementation of a non-destructive reading of the stored data, based on the asymmetrical behavior of the ferroelectric material about its two stable states (points “b” and “e” of FIG. 1 plot). In brief, and as will be explained in detail in what follows, it is proposed to apply to the ferroelectric material a low-voltage read signal (with an amplitude much smaller than the coercive voltage V_{c}), and to determine the variation of charge (or, equivalently, of polarization) occurring in the ferroelectric material under dynamic conditions, during application of the read signal. The charge variation in the material differs according to the datum stored (and hence according to the stable state previously reached by the material) in so far as the hysteresis plot differs in the surroundings of the stable state.

As is evident from FIG. 1, the slope of the hysteresis plot about the two stable states is different, and in particular: for negative read voltages it is greater for a positive starting polarization +Q_{H} with respect to the negative polarization −Q_{H} (and consequently causes a greater charge variation), whereas for positive read voltages it is greater for a negative starting polarization −Q_{H} with respect to the positive polarization +Q_{H}. From the amount of charge variation (which, as has been said, differs according to the starting polarization of the ferroelectric material) it is thus possible to determine the stored datum, without the reading operation causing cancellation thereof.

FIG. 2 shows a reading device 1 implementing the non-destructive reading technique. A ferroelectric capacitor 2 represents the ferroelectric storage material, and has a first terminal 2a connected to a reference potential (for example, to the circuit ground), and a second terminal 2b.

In detail, the reading device 1 includes: a voltage generator 3, designed to be connected to the second terminal 2b of the ferroelectric capacitor 2, and to generate a read signal Vᵣ; a processing stage 4, connected to the second terminal 2b of the ferroelectric capacitor 2, and designed to detect and process a charge variation ΔQ occurring in the ferroelectric material as a consequence of application of the read signal Vᵣ, and to generate an output signal (for example, an output voltage signal Vₒᵤₜ) as a function of the charge variation ΔQ; and an analysis stage 5, connected to the output of the processing stage 4, and designed to determine the value of the read datum on the basis of the aforesaid charge variation ΔQ, and in particular of the value of the output signal Vₒᵤₜ (for example, by comparison with given threshold values).

In a first embodiment, illustrated in FIG. 3, the processing stage 4 includes: a transimpedance amplifier (TIA) for detection of the charge variation ΔQ, and consequently an operational amplifier 6 having a non-inverting terminal connected to the voltage generator 3 and receiving the read signal Vᵣ, an inverting terminal connected to the second terminal 2b of the ferroelectric capacitor 2, and an output terminal supplying the output signal Vₒᵤₜ; and a resistor 7 feedback-connected between the output terminal and the inverting terminal of the operational amplifier 6. In a known manner, feedback of the operational amplifier 6 sets the reading voltage Vᵣ also on the second terminal 2b (on account of the known virtual short circuit principle); the transimpedance amplifier receives at input a differential charge (hence a current) and supplies at output a voltage as a function of the charge variation.

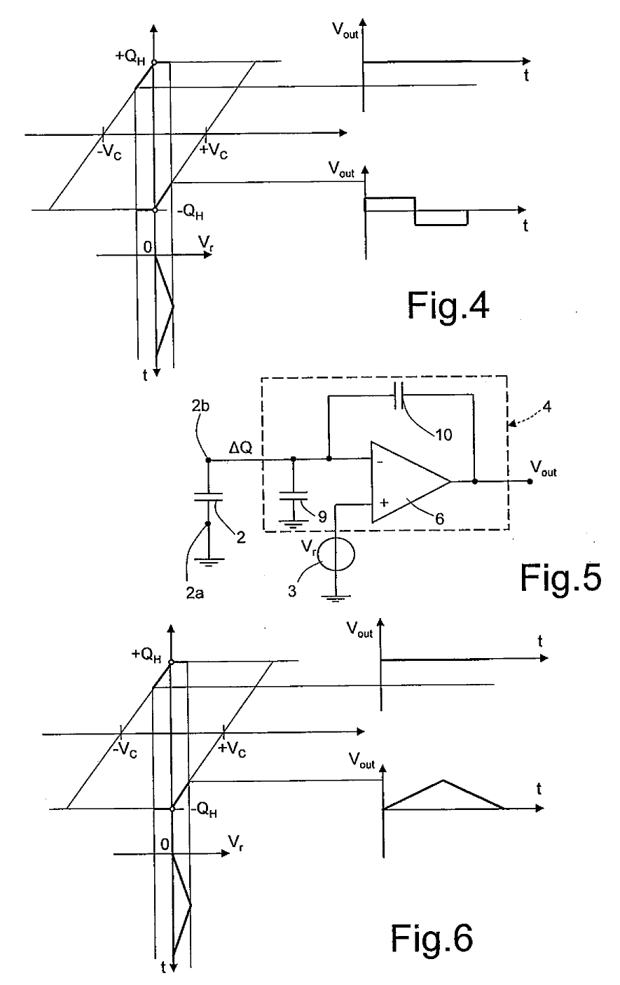

Operation of the proposed reading technique is illustrated with reference to FIG. 4, where, for reasons of clarity of illustration, the hysteresis loop of the ferroelectric material is simplified and modeled as a series of straight lines (so as to visually highlight the difference of slope about the two stable states).

On account of the application of the read signal Vᵣ, for example, a positive signal of a triangular type (and in any case lower than the coercive voltage of the ferroelectric material), the polarization moves along the maximum hysteresis loop: if the material has a negative starting polarization −Q_{H}, a variation of the charge stored in the ferroelectric material occurs, resulting in a variation of the output signal Vₒᵤₜ; instead, if the material has a positive starting polarization +Q_{H}, ideally no appreciable variation of the charge stored, and consequently of the output signal Vₒᵤₜ, occurs. Since the reading voltage Vᵣ is smaller than the coercive voltage V_{c}, the polarization returns to the starting stable state after application of the reading pulse. In particular, given the nature of the transimpedance amplifier, the output signal Vₒᵤₜ, in response to the triangular input signal, is a square wave constituted by the succession of a positive step and a negative step, with total duration equal to the reading pulse. If a negative reading pulse is applied, a result complementary to what has been described previously is obtained, with a non-zero output signal Vₒᵤₜ starting from a positive polarization +Q_{H}, and an output signal ideally zero starting from a negative polarization −Q_{H}.

It is emphasized that, also considering a real hysteresis loop, on account of the different slopes of the polarization diagram according to the starting stable state, a positive reading voltage will cause in any case a charge variation significantly greater where the starting point is a stable state with negative polarization as compared to the case where the starting point is, instead, a stable state with positive polarization (and vice versa, for a negative reading voltage).

Possibly, to enable a better analysis of the output signal Vₒᵤₜ, the analysis stage 5 can perform a correlation between the same output signal and the read signal Vᵣ, so as to obtain an output with non-zero mean value (once again only for one of the two stable states, the other originating an ideally zero signal); for example, a rectifier circuit, or multiplexer can be used for the purpose.

In a second embodiment (illustrated in FIG. 5), the processing stage 4 has a charge sensing amplifier (CSA), and consequently: an operational amplifier (again designated by 6) having a non-inverting terminal connected to the voltage generator 3 and receiving the read signal Vᵣ, an inverting terminal connected to the second terminal 2b of the ferroelectric capacitor 2, and an output terminal supplying the output voltage signal Vₒᵤₜ; a first capacitor 9 that is connected between the second terminal 2b of the ferroelectric capacitor 2 and the reference potential and represents the parasitic capacitances connected to the second terminal; and a second capacitor 10, feedback-connected between the output terminal and the inverting terminal of the operational amplifier 6. In a known manner, the charge amplifier supplies at its output a voltage, which is a function of the amount of charge that it receives at its input.

FIG. 6 shows the plot of electrical quantities in the reading device where a charge amplifier is used. Once again, when a positive reading pulse is applied, there is at output an appreciable signal only when the ferroelectric material has a negative starting polarization. In particular, in this case, the output signal Vₒᵤₜ has a triangular shape, corresponding to that of the read signal.

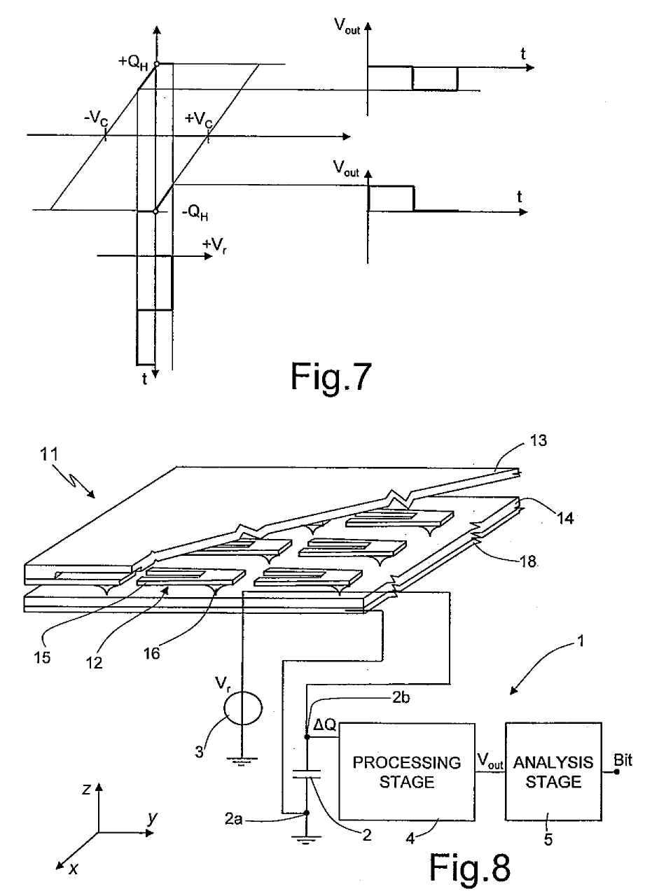

As a further example, FIG. 7 shows the output signal Vₒᵤₜ in response to a square-wave reading stimulus, once again using the charge amplifier for detecting the variation in polarization, in the two cases of positive and negative starting polarization.

The advantages of the reading device and method according to the disclosure are clear from the foregoing description.

In any case, it is once again emphasized that the reading operation described herein is non-destructive in so far as it is based on the application of reading pulses with amplitude smaller than the coercive voltage of the ferroelectric material so that the polarization of the material returns to the starting stable state once the operation of reading of data is terminated. Since the reading operation does not cause cancellation of the stored data, the presence of a data-retention buffer and rewriting of the read data are not necessary.

With respect to other non-destructive solutions, the reading technique described has a lower circuit complexity. In particular, a complex dedicated circuitry is not required, and it is possible to use circuits that are already present in the storage systems, with obvious advantages in terms of costs and of the manufacturing process.

Tests made by the present applicant have demonstrated that the use of a charge amplifier in the processing stage 4 guarantees a better signal-to-noise ratio as compared to other circuit solutions, and consequently ensures a greater reliability of the reading operations.

The device and the method described prove particularly advantageous for so-called “probe-storage systems” (also referred to as “atomic-storage systems”). These systems in fact enable high data-storage capacities in reduced dimensions and with low manufacturing costs.

By way of example (FIG. 8), a probe-storage system 11 includes a two-dimensional array of interaction structures (or probes) 12, fixed to a common substrate 13, for example, made of silicon; a control electronics (including the reading device 1) is provided in the common substrate 13, e.g., using CMOS technology. The array is set above a storage medium 14 made of ferroelectric material and is mobile relative to the storage medium, generally in a first and second direction x, y orthogonal to one another, as a result of the action of a micromotor associated thereto.

Each interaction structure 12 has: a carrier element 15 made of semiconductor material, in particular silicon (generally known as “cantilever” or “cantilever beam”), suspended in cantilever fashion above the storage medium 14 and moveable in a third direction z, orthogonal to the first and second directions x, y so as to approach the storage medium 14; and an interaction element 16 (defined also as “sensor” or “contact element”), made of conductive material, carried by the carrier element 15 at a free end thereof, and facing the storage medium 14 (where by the term “interaction” is meant any operation of reading, writing or erasure of one or more information bits, which implies an exchange of signals between the interaction structure 12 and the storage medium 14). Via the respective interaction element 16, of nanometric dimensions, each interaction structure 12 is able to interact locally at an atomic level with a portion of the storage medium 14 for writing, reading, or erasing information bits.

In detail, during reading operation, an electrode 18 set at the bottom in contact with the storage medium 14 is set at a reference potential (being the first terminal 2a of the ferroelectric capacitor 2), and the reading voltage Vᵣ is applied to the interaction element 6 (which constitutes, instead, the second terminal 2b of the ferroelectric capacitor 2). The charge variation in the ferroelectric material is thus detected and analyzed by the reading device 1, advantageously integrated in the substrate 13, for determining the bits read, according to the non-destructive technique previously described.

Finally, it is clear that modifications and variations can be made to what is described and illustrated herein, without thereby departing from the scope of the present invention, as defined in the annexed claims.

In particular, even though the foregoing description has made reference to the case where the ferroelectric material does not show hysteresis about the two stable states, so that the polarization moves always along the primary hysteresis loop defined by the preceding polarization operation, the described technique can be applied also to a ferroelectric material having mini-loops of hysteresis about the stable points. In fact, also in this case, it is possible to detect the datum stored, exploiting the different (asymmetrical) slopes of the polarization plot about the stable points. Alternatively, it is possible to prevent formation of the mini-loops of hysteresis, by applying a reading stimulus having a low value and such as to force the polarization to follow the primary hysteresis loop, or a reading stimulus having a frequency that is higher than the polarization capability of the media (for example, of the order of kHz or MHz).

It is evident that, in the reading device 1, other circuit configurations can be used for detecting and amplifying the variation of charge (or of polarization) generated by the read signal in the ferroelectric material, according also to the type of the read signal and of the desired signal-to-noise ratio. For example, a differential-input charge amplifier could be used, or else more or less complex blocks for filtering the output signal Vₒᵤₜ could be introduced, to facilitate the analysis of the output signal.

The read signal Vᵣ can have other waveforms, for example, it may be sinusoidal, square-wave, etc., and can possibly be an a.c. voltage. The read signal can moreover be impulsive or periodic and have different amplitudes according to the type of ferroelectric material (in any case, always lower than the coercive voltage of the material).

Finally, it is evident that the non-destructive reading technique described can be advantageously applied in different storage systems based upon ferroelectric material, for example, in FeRAMs (Ferroelectric RAMs) comprising a plurality of memory cells including ferroelectric material.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for non-destructive reading of a datum stored in a ferroelectric material in a stable state of polarization, comprising:
applying a read electrical quantity to said ferroelectric material, having a value such as not to cause a variation of stable state of polarization of said ferroelectric material;
generating an output quantity indicative of a polarization charge variation occurring in said ferroelectric material during application of said read electrical quantity; and
determining the value of the stored datum based on said output quantity.

2. The method of claim 1 wherein said read electrical quantity is a read voltage having an amplitude smaller than a coercive voltage of said ferroelectric material.

3. The method of claim 1 wherein said polarization charge variation is given by a difference between a first value assumed by the polarization charge in said stable state of said ferroelectric material, and a second value assumed by said polarization charge during application of said read electrical quantity.

4. The method of claim 1 wherein generating said output quantity comprises generating a first output quantity indicative of a first variation of polarization charge, in the case where said datum stored in said ferroelectric material has a first value, and generating a second output quantity indicative of a second variation of polarization charge, in the case where said datum stored in said ferroelectric material has a second value; said first and second variations of polarization charge having different values according to a different slope in a hysteresis loop of said ferroelectric material starting from said stable state of polarization corresponding to the datum stored.

5. The method of claim 1 wherein said output quantity is a voltage, and generating said output quantity comprises detecting and processing said polarization charge variation by means of a transimpedance amplifier.

6. The method of claim 1 wherein said output quantity is a voltage, and generating said output quantity comprises detecting and processing said polarization charge variation by means of a charge amplifier.

7. The method of claim 1 wherein determining the value of said stored datum comprises performing a correlation between said output quantity and said read electrical quantity.

8. The method of claim 1 wherein said read electrical quantity has a waveform of one from among a triangular, sinusoidal, or square waveform.

9. The method of claim 8 wherein said read electrical quantity has an impulsive or periodic waveform.

10. The method of claim 1 wherein said read electrical quantity is a read voltage having a value such as not to generate in said ferroelectric material a mini-loop of hysteresis about said stable state of polarization.

11. The method of claim 10 wherein said read voltage has a frequency higher than a polarization capability of said ferroelectric material.

12. A device for non-destructive reading of a datum stored in a ferroelectric material in a stable state of polarization, comprising:
applying means configured to apply to said ferroelectric material a read electrical quantity having a value such as not to cause a variation of the stable state of polarization thereof;
generating means configured to generate an output quantity indicative of a polarization charge variation occurring in said ferroelectric material during application of said read electrical quantity; and
determining means configured to determine the value of said datum based on said output quantity.

13. The device of claim 12 wherein said read electrical quantity is a read voltage having an amplitude smaller than an amplitude of a coercive voltage of said ferroelectric material.

14. The device of claim 12 wherein said polarization charge variation is given by a difference between a first value assumed by said polarization charge in said stable state of said ferroelectric material and a second value assumed by said polarization charge during application of said read electrical quantity.

15. The device of claim 12 wherein said ferroelectric material is arranged between a first electrode and a second electrode forming a capacitor with charge varying as a function of its polarization, and said generating means are connected directly to at least one between said first and second electrodes.

16. The device of claim 12 wherein said output quantity is a voltage, and said generating means comprise transimpedance-amplifier means, configured to detect and process said polarization charge variation.

17. The device of claim 12 wherein said output quantity is a voltage, and said generating means comprise charge-amplifier means, configured to detect and process said polarization charge variation.

18. The device of claim 12 wherein said determining means further comprise correlation means configured to perform a correlation between said output quantity and said read electrical quantity.

19. The device of claim 12 wherein said read electrical quantity has a waveform that is one from among a triangular, sinusoidal, or square waveform.

20. The device of claim 19 wherein said read electrical quantity has an impulsive or periodic waveform.

21. The device of claim 19 wherein said read electrical quantity has a frequency higher than a polarization capability of said ferroelectric material.

22. A storage system comprising a ferroelectric storage media, comprising a reading device according to claim 12 associated with said ferroelectric storage media.

23. The system of claim 22 of a “probe storage” type, comprising at least one interaction structure associated with said storage media, and provided with a carrier element set above said storage media and an interaction element carried by said carrier element and designed to interact with said storage media; said generating means connected to said interaction element.

24. A method of reading a state of a ferroelectric storage device, comprising:
subjecting the ferroelectric storage device to a read electric voltage that does not change the state of the ferroelectric storage device;
generating an output quantity responsive to the electric voltage and to the state of the ferroelectric storage device; and
determining a value associated with a state of the ferroelectric storage device in response to the output quantity.

25. The method of claim 24 wherein the read electric voltage has an amplitude smaller than a coercive voltage of the ferroelectric storage device.

26. The method of claim 25 wherein the output quantity is indicative of a polarization charge variation in the ferroelectric storage device that is the difference between a first value of the polarization charge in a stable state of the ferroelectric storage device and a second value of the polarization charge that is generated during application of the read electric voltage.

27. A device for reading a state of a ferroelectric storage device, the device comprising:
a voltage generator configured to subject the ferroelectric storage device to a read electric voltage that does not change the state of the ferroelectric storage device;
a processing stage adapted to generate an output quantity responsive to the electric voltage and to the state of the ferroelectric storage device; and
an analysis stage adapted to determine a value associated with a state of the ferroelectric storage device in response to the output quantity.

28. The device of claim 27 wherein the read electric voltage has an amplitude smaller than a coercive voltage of the ferroelectric storage device.

29. The device of claim 28 wherein the output quantity generated by the processing stage is indicative of a polarization charge variation in the ferroelectric storage device that is the difference between a first value of the polarization charge in a stable state of the ferroelectric storage device and a second value of the polarization charge when the ferroelectric storage device is subjected to the read electric voltage.
